(19) United States
(12) Patent Application Publication
(10) Pub. No.: US 2022/0246346 A1
(43) Pub. Date: Aug. 4, 2022

(54) MULTILAYER COIL COMPONENT

(71) Applicant: TDK CORPORATION, Tokyo (JP)

(72) Inventors: Yuto SHIGA, Tokyo (JP); Youichi KAZUTA, Tokyo (JP); Yuichi TAKUBO, Tokyo (JP); Junichiro URABE, Tokyo (JP); Noriaki HAMACHI, Tokyo (JP); Kazuya TOBITA, Tokyo (JP); Toshinori MATSUURA, Tokyo (JP)

(73) Assignee: TDK CORPORATION, Tokyo (JP)

(21) Appl. No.: 17/590,888

(22) Filed: Feb. 2, 2022

(30) Foreign Application Priority Data
Feb. 4, 2021 (JP) 2021-016575

(51) Int. Cl. H01F 27/29; H01F 27/32; H01F 41/04; H01F 27/28

(52) U.S. Cl. CPC H01F 27/29; H01F 27/32; H01F 2027/2809; H01F 27/2804; H01F 41/041

(57) ABSTRACT

A multilayer coil component includes: an element body including a plurality of insulator layers that are laminated; a coil; and a pair of external terminals. The element body has a rectangular parallelepiped shape. The element body includes a pair of main surfaces opposing each other in a first direction, a pair of end surfaces opposing each other in a second direction, and a pair of side surfaces opposing each other in a third direction. The pair of external terminals are separated from each other in the second direction. The pair of external terminals are embedded in the element body apart from the pair of end surfaces and the pair of side surfaces. Each of the pair of external terminals includes an exposed surface exposed from one of the main surfaces and an inner surface disposed in the element body. The inner surface includes a depression or a protrusion.

### TECHNICAL FIELD

The present disclosure relates to a multilayer coil component.

### BACKGROUND

Japanese Unexamined Patent Publication No. 2018-113299 discloses a multilayer coil component including an element body, a coil, and a pair of external electrodes. In this multilayer coil component, the external electrode is embedded in the element body in such a way as to be exposed from the bottom surface of the element body.

### SUMMARY

Peeling of the external electrode from the element body may occur in the above electronic component.

One aspect of the present disclosure provides a multilayer coil component capable of suppressing peeling of an external terminal.

A multilayer coil component according to one aspect of the present disclosure includes: an element body including a plurality of insulator layers that are laminated; a coil disposed in the element body; and a pair of external terminals electrically connected to the coil. The element body has a rectangular parallelepiped shape. The element body includes a pair of main surfaces opposing each other in a first direction, a pair of end surfaces opposing each other in a second direction intersecting with the first direction, and a pair of side surfaces opposing each other in a third direction intersecting with the first direction and the second direction. The pair of external terminals are separated from each other in the second direction. The pair of external terminals are embedded in the element body apart from the pair of end surfaces and the pair of side surfaces. Each of the pair of external terminals includes an exposed surface exposed from one of the main surfaces and an inner surface disposed in the element body. The inner surface includes a depression or a protrusion.

In the multilayer coil component, the external terminal includes the inner surface disposed in the element body. The inner surface is provided with a depression or a protrusion. As a result, the area of contact between the element body and the external terminal increases. As a result, the adhesiveness of the external terminal with respect to the element body is improved. As a result, peeling of the external terminal can be suppressed.

The inner surface may include an opposing surface opposing the exposed surface and a connecting surface connecting the exposed surface and the opposing surface. The connecting surface may include a depression or a protrusion. In this case, the depression or the protrusion is easily caught with respect to stress in the first direction. As a result, peeling of the external terminal is suppressed with ease.

The connecting surface may include a pair of first connecting surfaces opposing each other in the second direction. Each of the pair of first connecting surfaces may include a depression or a protrusion. In this case, peeling of the external terminal can be suppressed as compared with a case where the depression or the protrusion is provided at only one first connecting surface.

The connecting surface may include a pair of second connecting surfaces opposing each other in the third direction. Each of the pair of second connecting surfaces may include a depression or a protrusion. In this case, peeling of the external terminal can be reliably suppressed as compared with a case where the depression or the protrusion is provided at only one second connecting surface.

The connecting surface may include a depression adjacent to a corner portion of the main surface when viewed from the first direction. In this case, the area of the element body in the corner portion of the main surface increases. As a result, damage to the corner portion of the main surface can be suppressed.

The connecting surface may include a depression or a protrusion extending along a direction intersecting with the first direction. In this case, the depression or the protrusion functions as an anchor and is caught on the element body. As a result, peeling of the external terminal can be further suppressed.

The inner surface may include an opposing surface opposing the exposed surface. The opposing surface may include a depression or a protrusion. In this case, the depression or the protrusion is easily caught with respect to stress in the second direction or the third direction. As a result, peeling of the external terminal is easily suppressed.

The opposing surface may include a depression or a protrusion having an annular shape when viewed from the first direction. In this case, the depression or the protrusion is unlikely to be uneven in each of the second direction and the third direction with respect to the opposing surface. As a result, distortion attributable to shrinkage during firing is unlikely to occur.

Each of the pair of external terminals may include a plurality of electrode layers that are laminated. In this case, the external terminal can be formed together with the element body by laminating the electrode layers together with the insulator layers.

The plurality of electrode layers may be laminated in such a way that electrode layers having different shapes when viewed from a lamination direction are adjacent to each other. In this case, a depression or a protrusion can be easily formed at the inner surface.

### BRIEF DESCRIPTION OF THE DRAWINGS

FIG. 1 is a perspective view of a multilayer coil component according to a first embodiment.

FIG. 2 is an exploded perspective view of the multilayer coil component of FIG. 1.

FIG. 3 is a bottom view of the multilayer coil component of FIG. 1.

FIG. 4 is a side view of the external terminal illustrated in FIG. 1.

FIG. 5 is a bottom view of a multilayer coil component according to a first modification example of the first embodiment.

FIG. 6 is a bottom view of a multilayer coil component according to a second modification example of the first embodiment.

FIG. 7 is a bottom view of a multilayer coil component according to a third modification example of the first embodiment.

FIG. 8 is a bottom view of a multilayer coil component according to a fourth modification example of the first embodiment.

FIG. 9 is a perspective view of a multilayer coil component according to a second embodiment.

FIG. 10A is a top view of the external terminal illustrated in FIG. 9, and FIG. 10B is a cross-sectional view of the external terminal illustrated in FIG. 9.

FIG. 11A is a top view of an external terminal according to a first modification example of the second embodiment.

FIG. 11B is a cross-sectional view of the external terminal according to the first modification example of the second embodiment.

FIG. 12A is a top view of an external terminal according to a second modification example of the second embodiment.

FIG. 12B is a top view of an external terminal according to a third modification example of the second embodiment.

FIG. 12C is a top view of an external terminal according to a fourth modification example of the second embodiment.

FIG. 13 is a cross-sectional view of an external terminal according to a fifth modification example of the second embodiment.

FIG. 14 is a perspective view of a multilayer coil component according to a third embodiment.

FIG. 15 is a cross-sectional view of the external terminal illustrated in FIG. 14.

### DETAILED DESCRIPTION

Hereinafter, embodiments will be described in detail with reference to the accompanying drawings. In the description of the drawings, the same or equivalent elements are denoted by the same reference numerals with redundant description omitted.

### First Embodiment

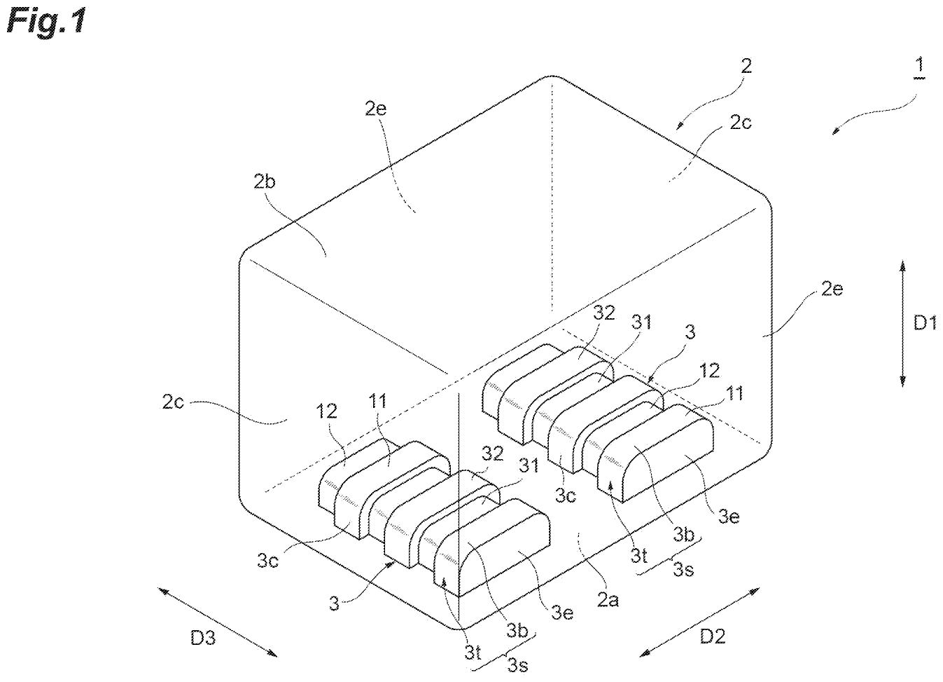

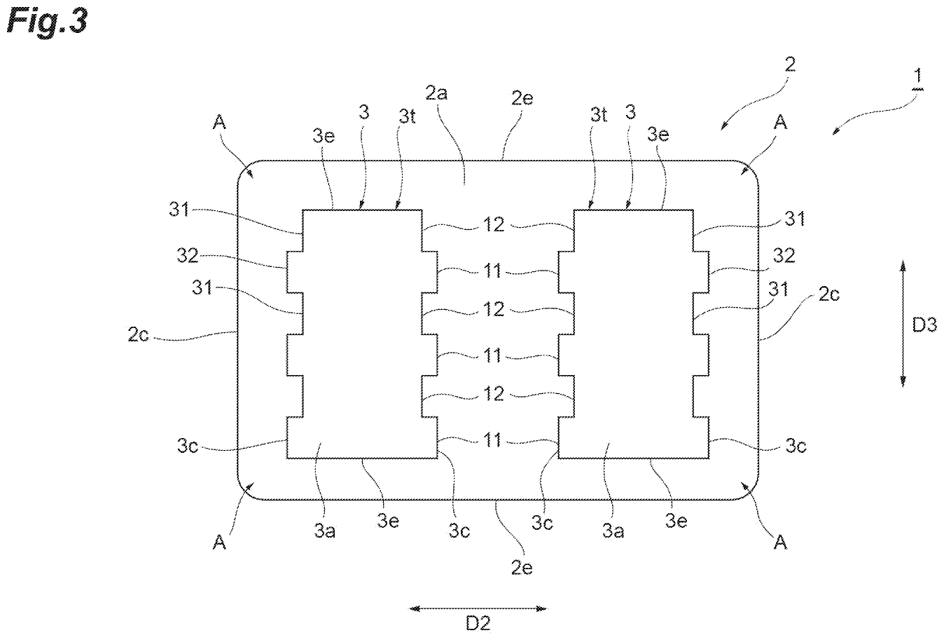

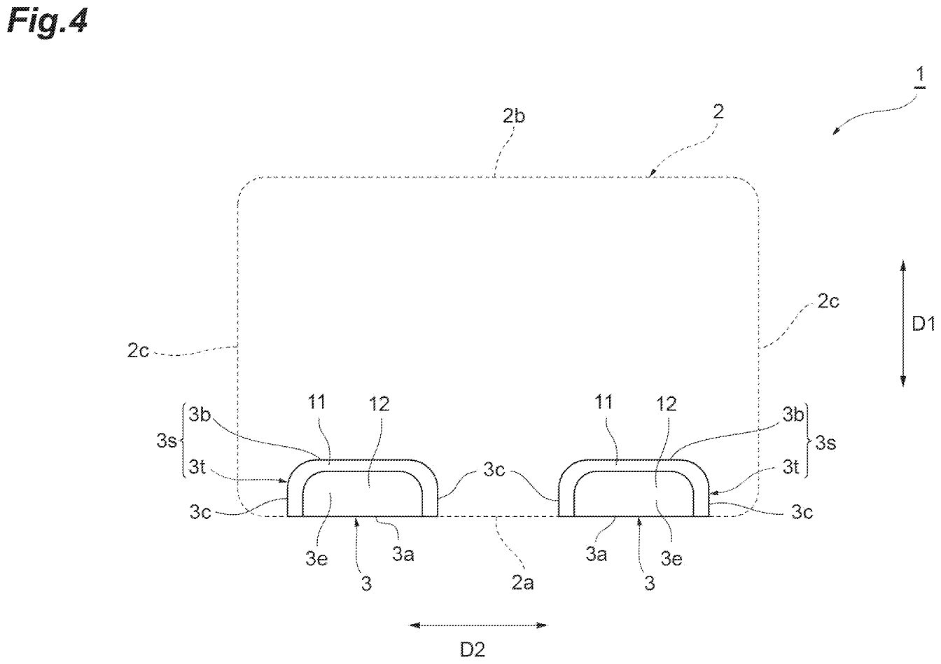

As illustrated in FIGS. 1 to 4, a multilayer coil component 1 according to a first embodiment includes an element body 2 having a rectangular parallelepiped shape, a pair of external terminals 3, a coil 10, and connecting conductors 26 and 27. The rectangular parallelepiped shape includes a rectangular parallelepiped shape in which the corner and ridge portions are chamfered and a rectangular parallelepiped shape in which the corner and ridge portions are rounded. The multilayer coil component 1 is, for example, a multilayer high-frequency inductor. In FIG. 1, the external terminal 3 in the element body 2 is indicated by a solid line.

The element body 2 has main surfaces 2a and 2b opposing each other, a pair of end surfaces 2c opposing each other, and a pair of side surfaces 2e opposing each other. In the following description, the direction in which the main surfaces 2a and 2b oppose each other is a first direction D1, the direction in which the pair of end surfaces 2c oppose each other is a second direction D2, and the direction in which the pair of side surfaces 2e oppose each other is a third direction D3. The first direction D1, the second direction D2, and the third direction D3 intersect (are orthogonal here). In the present embodiment, the first direction D1 is the height direction of the element body 2. The second direction D2 is the length direction of the element body 2. The third direction D3 is the width direction of the element body 2.

Each of the main surfaces 2a and 2b, the pair of end surfaces 2c, and the pair of side surfaces 2e has a rectangular shape. The long side direction of the main surfaces 2a and 2b matches the second direction D2. The short side direction of the main surfaces 2a and 2b matches the third direction D3. The main surface 2a is adjacent to each end surface 2c and each side surface 2e. The main surface 2b is adjacent to each end surface 2c and each side surface 2e. Each end surface 2c is adjacent to each side surface 2e.

The main surfaces 2a and 2b extend in the second direction D2 in such a way as to interconnect the pair of end surfaces 2c. The main surfaces 2a and 2b also extend in the third direction D3 in such a way as to interconnect the pair of side surfaces 2e. The pair of end surfaces 2c extend in the first direction D1 in such a way as to interconnect the main surfaces 2a and 2b. The pair of end surfaces 2c also extend in the third direction D3 in such a way as to interconnect the pair of side surfaces 2e. The pair of side surfaces 2e extend in the first direction D1 in such a way as to interconnect the main surfaces 2a and 2b. The pair of side surfaces 2e also extend in the second direction D2 in such a way as to interconnect the pair of end surfaces 2c. The multilayer coil component 1 is, for example, solder-mounted on an electronic device (such as a circuit board and an electronic component). In the multilayer coil component 1, the main surface 2a constitutes a mounting surface opposing an electronic device.

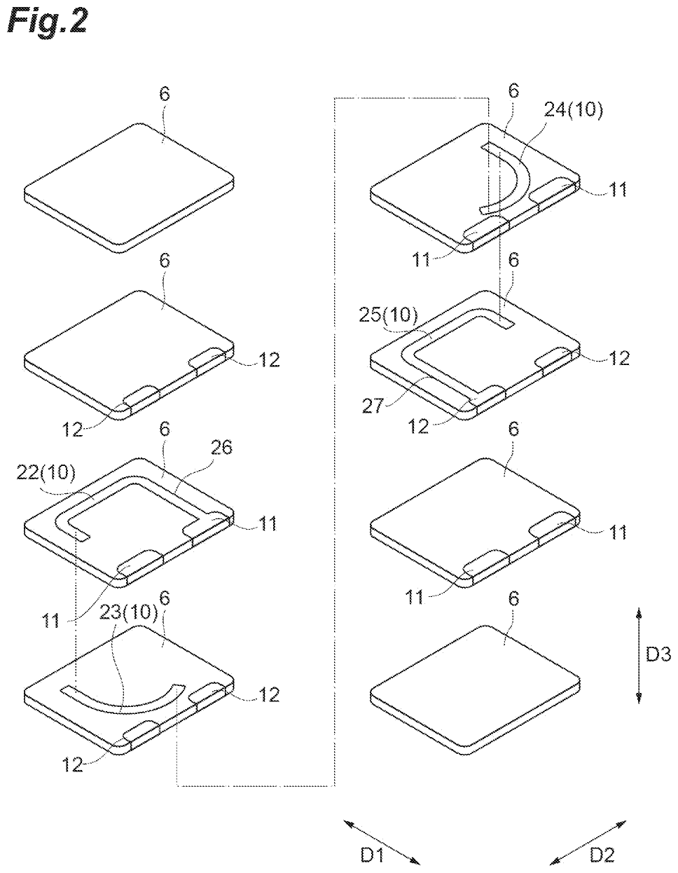

As illustrated in FIG. 2, the element body 2 is configured by laminating a plurality of insulator layers 6 in the third direction D3. The element body 2 has the plurality of insulator layers 6 laminated in the first direction D1. In the element body 2, the lamination direction in which the plurality of insulator layers 6 are laminated matches the third direction D3. In the actual element body 2, the plurality of insulator layers 6 are integrated to the extent that the boundaries between the insulator layers 6 cannot be visually recognized.

Each insulator layer 6 is formed of a dielectric material containing a glass component. In other words, the element body 2 contains a dielectric material containing a glass component as a compound of elements constituting the element body 2. Examples of the glass component include borosilicate glass. The dielectric material is, for example, dielectric ceramic such as BaTiO₃-based dielectric ceramic, Ba(Ti,Zr)O₃-based dielectric ceramic, and (Ba,Ca)TiO₃-based dielectric ceramic. Each insulator layer 6 is configured from a fired body of a ceramic green sheet containing a glass ceramic material.

Each of the pair of external terminals 3 illustrated in FIGS. 1 to 4 is electrically connected to an end portion of the coil 10. The pair of external terminals 3 are embedded in the element body 2 in such a way as to be exposed from the main surface 2a. The pair of external terminals 3 are not exposed on the main surface 2b, the pair of end surfaces 2c, and the pair of side surfaces 2e. The pair of external terminals 3 are separated from each other in the second direction D2. The pair of external terminals 3 are separated from each of the pair of end surfaces 2c and the pair of side surfaces 2e when viewed from the direction orthogonal to the main surface 2a (first direction D1). One of the external terminals 3 is provided on one end surface 2c side of the element body 2. The other external terminal 3 is provided on the other end surface 2c side of the element body 2. The pair of external terminals 3 have the same shape as each other.

It can be said that the pair of external terminals 3 are disposed in a pair of depressions provided in the main surface 2a. Each depression is a space recessed from the main surface 2a to the inside of the element body 2. Each depression has a shape corresponding to the shape of the corresponding external terminal 3. Each external terminal 3 is in gapless contact with the entire inner surface of the corresponding depression.

Each external terminal 3 has a substantially rectangular plate shape in which the first direction D1 is the thickness direction. Each external terminal 3 has an exposed surface 3a exposed from the main surface 2a and an inner surface 3s disposed in the element body 2. The exposed surface 3a faces the outside of the element body 2 and is exposed from the main surface 2a. Although the exposed surface 3a is positioned in substantially the same plane as the main surface 2a, the exposed surface 3a may be positioned outside the element body 2 beyond the main surface 2a or inside the element body 2 beyond the main surface 2a.

The inner surface 3s is disposed in such a way as to oppose the element body 2 and is not exposed from the main surface 2a. The inner surface 3s is in gapless contact with the element body 2. The inner surface 3s has an opposing surface 3b and a connecting surface 3t. The opposing surface 3b opposes the exposed surface 3a in the thickness direction (first direction D1). The opposing surface 3b faces the inside of the element body 2 and opposes the main surface 2b. When viewed from the first direction D1, the exposed surface 3a and the opposing surface 3b have, for example, a rectangular shape. The long side directions of the exposed surface 3a and the opposing surface 3b match the third direction D3. The short side directions of the exposed surface 3a and the opposing surface 3b match the second direction D2.

The connecting surface 3t connects the exposed surface 3a and the opposing surface 3b. The connecting surface 3t includes a pair of first connecting surfaces 3c and a pair of second connecting surfaces 3e. Each of the pair of first connecting surfaces 3c and the pair of second connecting surfaces 3e connects the exposed surface 3a and the opposing surface 3b. The first connecting surface 3c and the second connecting surface 3e are disposed adjacent to each other.

The pair of first connecting surfaces 3c oppose each other in the second direction D2. The pair of first connecting surfaces 3c face away from each other in the second direction D2. One of the first connecting surfaces 3c faces the outside of the element body 2, and the other first connecting surface 3c faces the inside of the element body 2. The pair of external terminals 3 are disposed in such a way that the other first connecting surfaces 3c oppose each other. One of the first connecting surfaces 3c opposes the corresponding end surface 2c. The corresponding end surface 2c is the closer of the pair of end surfaces 2c. The pair of second connecting surfaces 3e oppose each other in the third direction D3. The pair of second connecting surfaces 3e face away from each other in the third direction D3. Each second connecting surface 3e opposes the corresponding side surface 2e. The corresponding side surface 2e is the closer of the pair of side surfaces 2e.

The external terminal 3 is configured by laminating a plurality of electrode layers 11 and 12 in the third direction D3. The external terminal 3 has the plurality of electrode layers 11 and 12 laminated in the third direction D3. The plurality of electrode layers 11 and 12 are disposed alternately. The electrode layers 11 and 12 have different shapes when viewed from the lamination direction (third direction D3). In the present embodiment, the electrode layers 11 and 12 are similar in shape to each other when viewed from the lamination direction. The plurality of electrode layers 11 and 12 are laminated in such a way that the electrode layers 11 and 12 similar in shape to each other when viewed from the lamination direction are adjacent to each other.

The electrode layers 11 and 12 are disposed in such a way that the positions of the side surfaces constituting the exposed surface 3a in the first direction D1 match. The planar exposed surface 3a is formed as a result. The electrode layer 11 is larger than the electrode layer 12 when viewed from the lamination direction. The electrode layers 11 and 12 are disposed in such a way that the middle positions in the second direction D2 match. As a result, the opposing surface 3b and the pair of first connecting surfaces 3c have a plurality of depressions 31 and a plurality of protrusions 32.

The plurality of depressions 31 and the plurality of protrusions 32 are alternately disposed in the third direction D3. The opposing surface 3b and the pair of first connecting surfaces 3c have an uneven shape. The plurality of depressions 31 have the same shape and the same depth. The plurality of protrusions 32 have the same shape and the same height. The uneven shapes of the pair of first connecting surfaces 3c are equivalent to each other. Each second connecting surface 3e is depression-less or protrusion-less.

The depression 31 is a groove provided in such a way as to be continuous over the opposing surface 3b and the pair of first connecting surfaces 3c as a whole. The depression 31 provided in the opposing surface 3b and the depression 31 provided in each first connecting surface 3c are connected to each other. The depression 31 has a rectangular cross section. The protrusion 32 is a projection provided in such a way as to be continuous over the opposing surface 3b and the pair of first connecting surfaces 3c as a whole. The protrusion 32 is a projection having a rectangular cross section. The protrusion 32 provided on the opposing surface 3b and the protrusion 32 provided on each first connecting surface 3c are connected to each other. The protrusion 32 has a rectangular cross section.

The depression 31 and the protrusion 32 are provided over the entire first connecting surface 3c in the first direction D1 and reach the exposed surface 3a. As a result, the pair of long sides of the exposed surface 3a have uneven shapes equivalent to each other. The pair of end portions of the exposed surface 3a in the second direction D2 have uneven shapes equivalent to each other.

The depression 31 is provided in the connecting surface 3t in such a way as to be adjacent to a corner portion A of the main surface 2a when viewed from the first direction D1. The corner portion A of the main surface 2a is positioned between the end surface 2c and the side surface 2e adjacent to each other. In the present embodiment, two adjacent depressions 31 are provided with respect to only two corner portions A disposed on one second connecting surface 3e side. Alternatively, adjacent depressions 31 may be provided with respect to four corner portions A.

The plurality of electrode layers 11 and 12 are integrated to the extent that the boundaries between the electrode layers 11 and 12 cannot be visually recognized. In the present embodiment, the number of the electrode layers 11 is “3” and the number of the electrode layers 12 is “3”. Each of the electrode layers 11 and 12 is provided in the defective portion that is formed in the corresponding insulator layer 6. The defective portion constitutes a depression. The electrode layers 11 and 12 contain a conductive material. The conductive material contains, for example, Ag or Pd. The electrode layers 11 and 12 are configured as fired bodies of conductive paste containing conductive material powder. The conductive material powder contains, for example, Ag powder or Pd powder.

The electrode layers 11 and 12 may further contain a glass component. In other words, the electrode layers 11 and 12 may be configured as fired bodies of conductive paste containing a glass component and a metal component made of conductive material powder. The glass component is a compound of elements constituting the element body 2 and is the same component as the glass component contained in the element body 2. The content of the glass component may be appropriately set. The electrode layers 11 and 12 extend along the second direction D2.

The coil 10 and the connecting conductors 26 and 27 are disposed in the element body 2 and are not exposed from the element body 2. The coil 10 has a coil axis along the third direction D3. The pair of end portions of the coil 10 are electrically connected to the pair of external terminals 3 (see FIG. 2). One of the end portions is electrically connected to one of the external terminals 3 by the connecting conductor 26. The other end portion is electrically connected to the other external terminal 3 by the connecting conductor 27.

The coil 10 has a first coil conductor 22, a second coil conductor 23, a third coil conductor 24, and a fourth coil conductor 25. The first coil conductor 22, the second coil conductor 23, the third coil conductor 24, and the fourth coil conductor 25 are disposed in this order along the first direction D1. The first coil conductor 22, the second coil conductor 23, the third coil conductor 24, and the fourth coil conductor 25 have a shape in which a part of a loop is interrupted. Each of the first coil conductor 22, the second coil conductor 23, the third coil conductor 24, and the fourth coil conductor 25 has one end portion and the other end portion.

The first coil conductor 22, the second coil conductor 23, the third coil conductor 24, and the fourth coil conductor 25 have a predetermined width (length in a direction intersecting with the first direction D1) and a predetermined height (length in the first direction). The first coil conductor 22, the second coil conductor 23, the third coil conductor 24, and the fourth coil conductor 25 are mutually equivalent in width and height.

The first coil conductor 22 is positioned in the same layer as the pair of electrode layers 11. The first coil conductor 22 is connected via the connecting conductor 26 to the other electrode layer 11 positioned in the same layer. The connecting conductor 26 is positioned in the same layer as the pair of electrode layers 11 and the first coil conductor 22. The connecting conductor 26 connects the first coil conductor 22 and the other electrode layer 11. One end portion of the first coil conductor 22 is connected to the connecting conductor 26. One end portion of the first coil conductor 22 constitutes the other end portion of the coil 10. In the present embodiment, the first coil conductor 22, the connecting conductor 26, and the other electrode layer 11 are integrally formed.

The second coil conductor 23 is positioned in the same layer as the pair of electrode layers 12. The second coil conductor 23 is separated from the pair of electrode layers 12 positioned in the same layer. The other end portion of the first coil conductor 22 and one end portion of the second coil conductor 23 are adjacent to each other in the first direction D1 and are in direct contact with each other. The other end portion of the first coil conductor 22 and one end portion of the second coil conductor 23 overlap when viewed from the first direction D1.

The third coil conductor 24 is positioned in the same layer as the pair of electrode layers 11. The third coil conductor 24 is separated from the pair of electrode layers 11 positioned in the same layer. The other end portion of the second coil conductor 23 and one end portion of the third coil conductor 24 are adjacent to each other in the first direction D1 and are in direct contact with each other. The other end portion of the second coil conductor 23 and one end portion of the third coil conductor 24 overlap when viewed from the first direction D1.

The fourth coil conductor 25 is positioned in the same layer as the pair of electrode layers 12. The fourth coil conductor 25 is connected via the connecting conductor 27 to one electrode layer 12 positioned in the same layer. The connecting conductor 27 is positioned in the same layer as the pair of electrode layers 12 and the fourth coil conductor 25. The connecting conductor 27 connects the fourth coil conductor 25 and one electrode layer 12. The other end portion of the fourth coil conductor 25 is connected to the connecting conductor 27. The other end portion of the fourth coil conductor 25 constitutes one end portion of the coil 10. In the present embodiment, the fourth coil conductor 25, the connecting conductor 27, and one electrode layer 12 are integrally formed.

The first coil conductor 22, the second coil conductor 23, the third coil conductor 24, the fourth coil conductor 25, and the connecting conductors 26 and 27 contain a conductive material. The conductive material contains, for example, Ag or Pd. The first coil conductor 22, the second coil conductor 23, the third coil conductor 24, the fourth coil conductor 25, and the connecting conductors 26 and 27 are configured as fired bodies of conductive paste containing conductive material powder. The conductive material powder contains, for example, Ag powder or Pd powder.

In the present embodiment, the first coil conductor 22, the second coil conductor 23, the third coil conductor 24, the fourth coil conductor 25, and the connecting conductors 26 and 27 contain the same conductive material as each external terminal 3. The first coil conductor 22, the second coil conductor 23, the third coil conductor 24, the fourth coil conductor 25, and the connecting conductors 26 and 27 may contain a conductive material different from the conductive material of each external terminal 3.

The first coil conductor 22, the second coil conductor 23, the third coil conductor 24, the fourth coil conductor 25, and the connecting conductors 26 and 27 are provided in the defective portions formed in the corresponding insulator layers 6. The first coil conductor 22, the second coil conductor 23, the third coil conductor 24, the fourth coil conductor 25, and the connecting conductors 26 and 27 are formed by firing the conductive paste that is positioned in a defective portion of a green sheet.

The defective portion of the green sheet is formed through the following process or the like. First, the green sheet is formed by applying element body paste containing the constituent material of the insulator layer 6 and a photosensitive material onto a base material. The base material is, for example, a PET film. The photosensitive material contained in the element body paste may be either a negative-type photosensitive material or a positive-type photosensitive material, and known photosensitive materials can be used. Next, the green sheet is exposed and developed by a photolithography method using a mask corresponding to the defective portion and the defective portion is formed in the green sheet on the base material. The green sheet where the defective portion is formed is an element body pattern.

The electrode layers 11 and 12, the first coil conductor 22, the second coil conductor 23, the third coil conductor 24, the fourth coil conductor 25, and the connecting conductors 26 and 27 are formed through the following process or the like.

First, a conductor material layer is formed by applying conductive paste containing a photosensitive material onto a base material. The photosensitive material contained in the conductive paste may be either a negative-type photosensitive material or a positive-type photosensitive material, and known photosensitive materials can be used. Next, the conductor material layer is exposed and developed by a photolithography method using a mask corresponding to a defective portion and a conductor pattern corresponding to the shape of the defective portion is formed on the base material.

The multilayer coil component 1 is obtained through, for example, the following process following the process described above. A sheet in which the element body pattern and the conductor pattern are in the same layer is prepared by combining the conductor pattern with the defective portion of the element body pattern. A laminate is obtained by laminating a predetermined number of the prepared sheets. After heat treatment is performed on the laminate, a plurality of green chips are obtained from the laminate. In this process, a green laminate or the like is cut into chips by a cutting machine. As a result, the plurality of green chips that have a predetermined size can be obtained. Next, the green chips are fired. The multilayer coil component 1 is obtained as a result of this firing. A plating layer may be formed on the surface of each external terminal 3. The plating layer is formed by, for example, electroplating or electroless plating. The plating layer contains, for example, Ni, Sn, or Au.

The multilayer coil component 1 is formed by a photolithography method as described above, and thus the external terminal 3 can be formed in any shape. In the above manufacturing method, the laminate is formed by laminating the predetermined number of prepared sheets after the sheet in which the element body pattern and the conductor pattern are in the same layer is prepared. Alternatively, the laminate may be formed by another method. For example, the laminate may be formed while sequentially forming the element body pattern and the conductor pattern by a photolithography method on one substrate for lamination. In other words, as long as the element body 2 includes the plurality of insulator layers 6 having a multilayer structure, the manufacturing method is not limited. As long as the external terminal 3 includes the plurality of electrode layers 11 and 12 having a multilayer structure, the manufacturing method is not limited.

As described above, in the multilayer coil component 1, the external terminal 3 has the inner surface 3s disposed in the element body 2 and the inner surface 3s has the depression 31 and the protrusion 32. As a result, the area of contact between the element body 2 and the external terminal 3 increases and the adhesiveness of the external terminal 3 with respect to the element body 2 is improved. As a result, peeling of the external terminal 3 can be suppressed.

The depression 31 and the protrusion 32 are provided at both the opposing surface 3b and the connecting surface 3t of the inner surface 3s. Accordingly, the area of contact between the element body 2 and the external terminal 3 further increases as compared with a case where only one of the opposing surface 3b and the connecting surface 3t has the depression 31 and the protrusion 32. As a result, peeling of the external terminal 3 can be further suppressed.

The depression 31 and the protrusion 32 are provided at each of the pair of first connecting surfaces 3c of the connecting surface 3t. Accordingly, the area of contact between the element body 2 and the external terminal 3 further increases as compared with a case where only one of the pair of first connecting surfaces 3c has the depression 31 and the protrusion 32. As a result, peeling of the external terminal 3 can be further suppressed.

Stress is likely to concentrate on the corner portion A. Accordingly, the corner portion A may be damaged by the external terminal 3 being disposed close to the corner portion A. In the multilayer coil component 1, the connecting surface 3t has the depression 31 adjacent to the corner portion A of the main surface 2a when viewed from the first direction D1. As a result, the area of the element body 2 in the corner portion A increases, and thus damage to the corner portion A can be suppressed. In other words, the external terminal 3 can be kept away from the corner portion A by the depression 31, and thus damage to the corner portion A (corner portion of the element body 2) is suppressed.

Each of the pair of external terminals 3 has the plurality of laminated electrode layers 11 and 12. Accordingly, the external terminal 3 can be formed together with the element body 2 by laminating the electrode layers 11 and 12 together with the insulator layer 6. The electrode layers 11 and 12 have different shapes when viewed from the lamination direction (third direction D3), and thus the inner surface 3s having the depression 31 and the protrusion 32 is easily formed by alternately laminating the electrode layers 11 and 12.

The pair of external terminals 3 are exposed only on the main surface 2a, and thus the mounting area can be reduced. In a case where, for example, the external terminal 3 is exposed on the main surface 2a and the end surface 2c, solder is formed on the end surface 2c side as well, and thus the mounting area increases.

Here, a form in which the coil 10 has the coil axis along the third direction D3 and has the first coil conductor 22, the second coil conductor 23, the third coil conductor 24, and the fourth coil conductor 25 has been described as an example. However, the coil axis of the coil 10 may not be along the third direction D3. The coil axis of the coil 10 may be along, for example, the first direction D1 or the second direction D2. In addition, the number of the coil conductors that constitute the coil 10 is not limited to “4”.

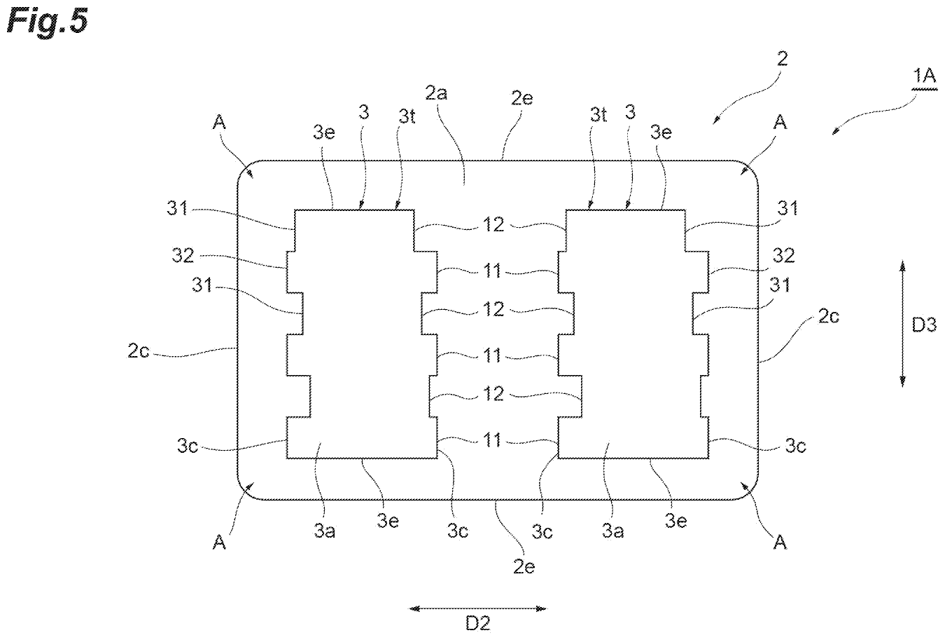

FIG. 5 is a bottom view of a multilayer coil component 1A according to a first modification example of the first embodiment. As illustrated in FIG. 5, in the multilayer coil component 1A, the plurality of electrode layers 12 are laminated with the positions in the second direction D2 changing whereas the plurality of electrode layers 11 are laminated with the positions in the second direction D2 fixed. The middle positions of the electrode layers 11 and 12 in the second direction D2 do not necessarily match. As a result, in the multilayer coil component 1A, the uneven shape of the inner surface 3s and the uneven shape of each long side of the exposed surface 3a become complex.

In the multilayer coil component 1A as well, the inner surface 3s has the depression 31 and the protrusion 32, and thus peeling of the external terminal 3 can be suppressed. Although the shapes of the pair of exposed surfaces 3a are equivalent to each other in the multilayer coil component 1A, the shapes of the pair of exposed surfaces 3a can be made different from each other by making the positions of the corresponding electrode layers 11 different from each other. In this case, the pair of external terminals 3 can be easily identified simply with the appearances thereof. In the multilayer coil component 1A, the plurality of electrode layers 11 instead of the plurality of electrode layers 12 may be laminated with the positions in the second direction D2 changing.

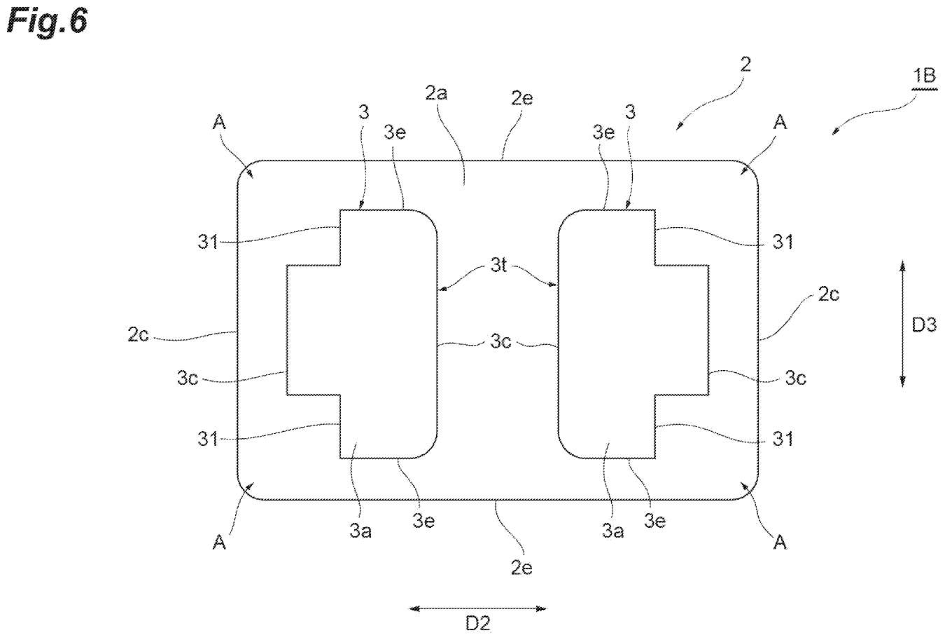

FIG. 6 is a bottom view of a multilayer coil component 1B according to a second modification example of the first embodiment. As illustrated in FIG. 6, in the multilayer coil component 1B, each connecting surface 3t has two depressions 31 adjacent to the corner portion A of the main surface 2a when viewed from the first direction D1. Each of the four corner portions A of the main surface 2a is adjacent to the corresponding depression 31. The depression 31 is provided over the entire connecting surface 3t in the first direction D1. The depression 31 is provided in such a way as to straddle one first connecting surface 3c and each second connecting surface 3e. The depression 31 is provided in the corner portion of the external terminal 3 that is formed by one first connecting surface 3c and each second connecting surface 3e.

The inner surface of the depression 31 is configured by a flat surface parallel to the end surface 2c and a flat surface parallel to the side surface 2e when viewed from the first direction D1. Although the external terminal 3 has a plurality of laminated electrode layers, the shape and the lamination direction of each electrode layer are not limited. The opposing surface 3b may or may not have the depression 31 or the protrusion 32.

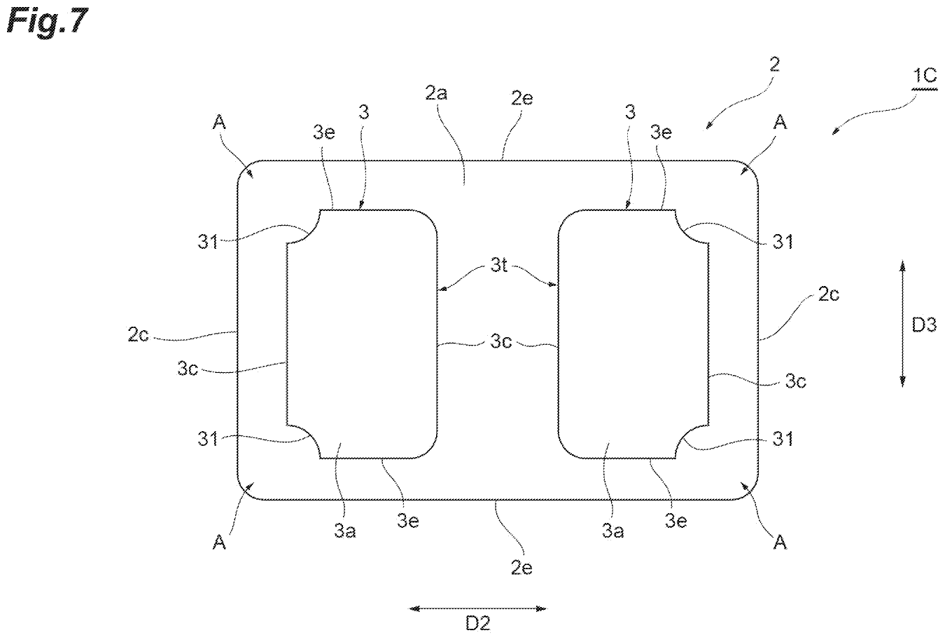

FIG. 7 is a bottom view of a multilayer coil component 1C according to a third modification example of the first embodiment. As illustrated in FIG. 7, in the multilayer coil component 1C as well as the multilayer coil component 1B illustrated in FIG. 6, each connecting surface 3t has two depressions 31 adjacent to the corner portion A of the main surface 2a when viewed from the first direction D1. The multilayer coil component 1C is different from the multilayer coil component 1B in that a curved surface constitutes the inner surface of the depression 31.

When viewed from the first direction D1, the depression 31 has a part recessed inside the external terminal 3 beyond the straight line that connects end portions of the first connecting surface 3c and the second connecting surface 3e. The chamfered shape having a straight line is not included in the depression 31 when viewed from the first direction D1. Although the external terminal 3 has a plurality of laminated electrode layers, the shape and the lamination direction of each electrode layer are not limited. The opposing surface 3b may or may not have the depression 31 or the protrusion 32.

In the multilayer coil components 1B and 1C as well, at least the connecting surface 3t has the depression 31, and thus peeling of the external terminal 3 can be suppressed. In addition, damage to the corner portion A is suppressed since the depression 31 is provided in such a way as to be adjacent to the corner portion A.

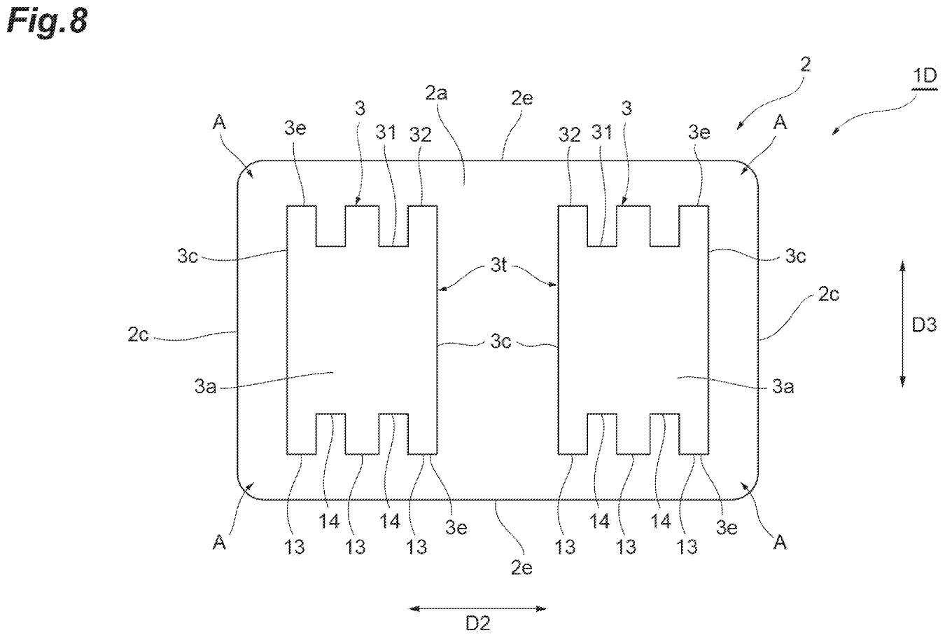

FIG. 8 is a bottom view of a multilayer coil component 1D according to a fourth modification example of the first embodiment. The multilayer coil component 1D illustrated in FIG. 8 is different from the multilayer coil component 1 in that the element body 2 has a plurality of insulator layers laminated in the second direction D2 and the external terminal 3 has a plurality of electrode layers 13 and 14 laminated in the second direction D2. The electrode layers 13 and 14 have different shapes (here, similar shapes) when viewed from, for example, the lamination direction (second direction D2). The number of the electrode layers 13 is “3”, and the number of the electrode layers 14 is “2”. The electrode layer 13 is larger than the electrode layer 14 when viewed from the lamination direction. The shapes of the coil 10 and the connecting conductors 26 and 27 are appropriately set in such a way that the coil 10 is connected to the pair of external terminals 3.

In the multilayer coil component 1D, the opposing surface 3b (see FIG. 1) and the pair of second connecting surfaces 3e have the plurality of depressions 31 and the plurality of protrusions 32. The plurality of depressions 31 and the plurality of protrusions 32 are alternately disposed in the second direction D2. The pair of short sides of the exposed surface 3a have uneven shapes equivalent to each other. In the multilayer coil component 1D as well, each of the opposing surface 3b and the pair of second connecting surfaces 3e has the depression 31 and the protrusion 32, and thus peeling of the external terminal 3 can be suppressed. The area of contact between the element body 2 and the external terminal 3 further increases as compared with a case where only one of the pair of second connecting surfaces 3e has the depression 31 and the protrusion 32. As a result, peeling of the external terminal 3 can be further suppressed.

In the multilayer coil component 1D, the middle positions of the electrode layers 13 and 14 in the third direction D3 match when viewed from the second direction D2. Alternatively, the positions may not match. In the external terminal 3, the electrode layer 13 is disposed in the end portion on the end surface 2c side that corresponds. Alternatively, the electrode layer 14 may be disposed in the end portion. In this case, the depression 31 can be disposed in the connecting surface 3t in such a way as to be adjacent to the corner portion A of the main surface 2a.

In the multilayer coil components 1, 1A, and 1D, the external terminal 3 may be configured simply by a plurality of electrode layers having the same shape when viewed from the lamination direction. Even in this case, the depression 31 and the protrusion 32 can be formed at the connecting surface 3t by the plurality of electrode layers being laminated while being shifted in the direction that is orthogonal to each of the lamination direction and the first direction D1. In other words, in the multilayer coil components 1 and 1A, the depression 31 and the protrusion 32 can be formed at the first connecting surface 3c by a plurality of electrode layers being laminated with the positions in the second direction D2 changing. In the multilayer coil component 1D, the depression 31 and the protrusion 32 can be formed at the second connecting surface 3e by a plurality of electrode layers being laminated with the positions in the third direction D3 changing.

In the multilayer coil components 1 and 1A, the external terminal 3 has the electrode layers 11 and 12 having different shapes. Alternatively, the external terminal 3 may have three or more types of electrode layers having different shapes. In the multilayer coil component 1D, the external terminal 3 has the electrode layers 13 and 14 having different shapes. Alternatively, the external terminal 3 may have three or more types of electrode layers having different shapes.

### Second Embodiment

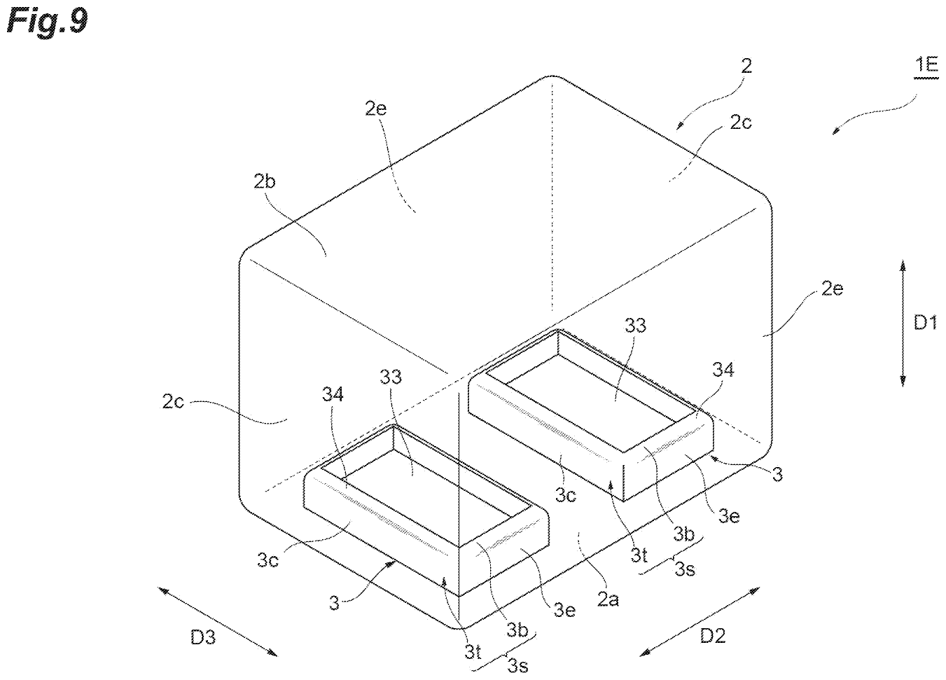

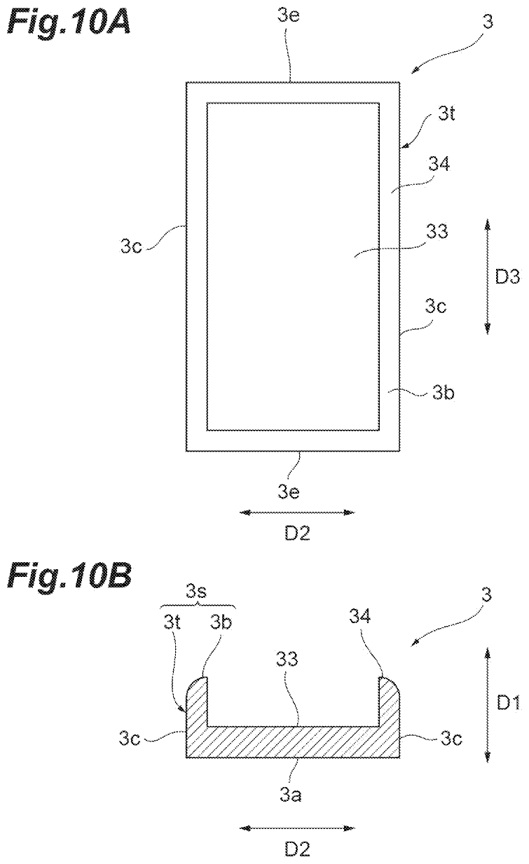

As illustrated in FIGS. 9, 10A, and 10B, a multilayer coil component 1E according to a second embodiment is different from the multilayer coil component 1 only in that the opposing surfaces 3b of the external terminals 3 have depressions 33 and protrusions 34 and the connecting surface 3t lacks a depression or a protrusion. In the multilayer coil component 1E, the opposing surface 3b has an uneven shape and the connecting surface 3t does not have an uneven shape.

In the multilayer coil component 1E, the opposing surface 3b has the protrusion 34 that is annular or frame-shaped when viewed from the first direction D1. The protrusion 34 is a projection that has a rectangular ring shape or a rectangular frame shape and protrudes in the first direction D1. Although the protrusion 34 in the present embodiment is continuous without being interrupted along the entire circumference of the connecting surface 3t, the protrusion 34 may be discontinuous insofar as the protrusion 34 is annular or frame-shaped as a whole. The depression 33 is provided inside the protrusion 34. The depression 33 has a rectangular shape when viewed from the first direction D1. The depression 33 has a rectangular cross section.

Although the external terminal 3 has a plurality of laminated electrode layers, the shape and the lamination direction of each electrode layer are not limited. The external terminal 3 is formed by, for example, laminating a plurality of electrode layers in the third direction D3. In this case, depression- and protrusion-less electrode layers may be laminated in both end portions in the lamination direction and the thickness-direction shape of those laminated in the rest in the lamination direction may match the cross-sectional shape illustrated in FIG. 10B.

Also in the multilayer coil component 1E, the opposing surface 3b is provided with the depression 33 and the protrusion 34, and thus the depression 33 and the protrusion 34 are easily caught with respect to stress in the second direction D2 or the third direction D3. As a result, peeling of the external terminal 3 is suppressed with ease. In addition, the area of contact between the external terminal 3 and the element body 2 increases, and thus peeling can be suppressed with respect to stress in the first direction D1 as well. The protrusion 34 is annular when viewed from the first direction D1, is disposed symmetrically with respect to a straight line parallel to the second direction D2 and passing through the center of the opposing surface 3b, and is disposed symmetrically with respect to a straight line parallel to the third direction D3 and passing through the center of the opposing surface 3b. By being annular as described above, the protrusion 34 is unlikely to be uneven in each of the second direction D2 and the third direction D3 with respect to the opposing surface 3b. As a result, distortion attributable to shrinkage during firing is unlikely to occur. Since the connecting surface 3t lacks a depression or a protrusion, the external terminal 3 can be reduced in size in the second direction D2 and the third direction D3.

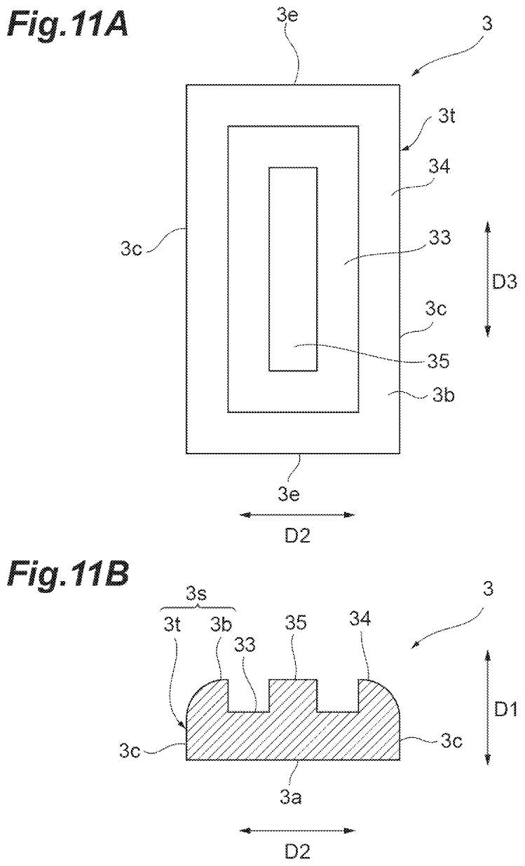

The opposing surface 3b of the external terminal 3 may further have a protrusion 35 as illustrated in FIGS. 11A and 11B. The protrusion 35 is provided apart from the protrusion 34 and on the middle portion of the bottom surface of the depression 33. Accordingly, the depression 33 is a groove that has a rectangular ring shape when viewed from the first direction D1. Although the depression 33 in the present embodiment is continuous without being interrupted along the entire circumference of the connecting surface 3t when viewed from the first direction D1, the depression 33 may be discontinuous insofar as the depression 33 is annular as a whole. The depression 33 as well as the protrusion 34 is annular, and thus distortion attributable to shrinkage during firing is unlikely to occur.

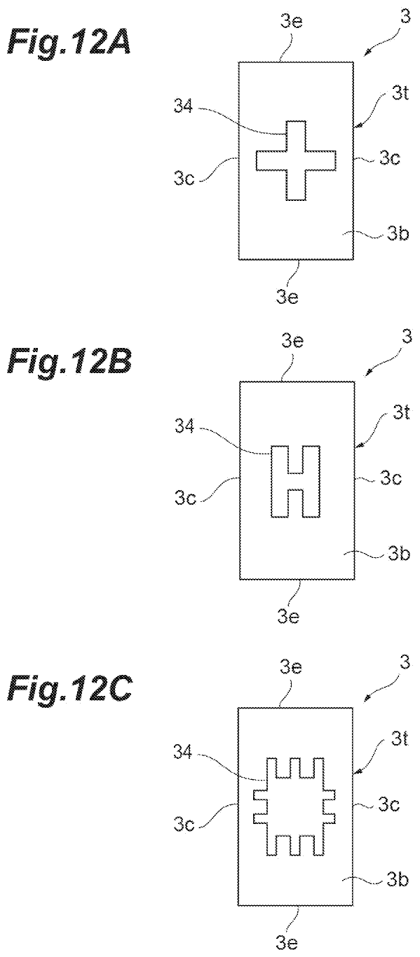

Although the protrusion 34 in the multilayer coil component 1E has an annular shape when viewed from the first direction D1, the shape is not limited. The opposing surface 3b may be provided with, for example, the plurality of protrusions 34 that are dot-shaped. In addition, the protrusion 34 that is viewed from the first direction D1 may have a cross shape as illustrated in FIG. 12A, may have an H shape as illustrated in FIG. 12B, or may be rectangular with each side having a projection as illustrated in FIG. 12C.

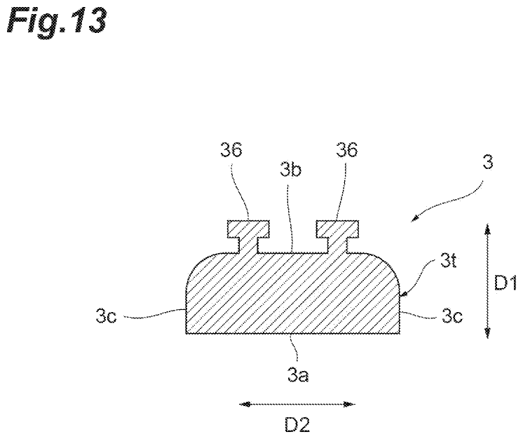

As illustrated in FIG. 13, the opposing surface 3b of the external terminal 3 may have a protrusion 36 that has a T-shaped cross section with the tip portion large in width (length in the second direction D2). For example, a plurality of the protrusions 36 may be provided in a dot shape on the opposing surface 3b. The wide tip portion of the protrusion 36 functions as an anchor and is caught on the element body 2. The shape of the protrusion 36 suppresses the movement of the external terminal 3 in the first direction D1 in particular. As a result, peeling of the external terminal 3 from the element body 2 is further suppressed.

### Third Embodiment

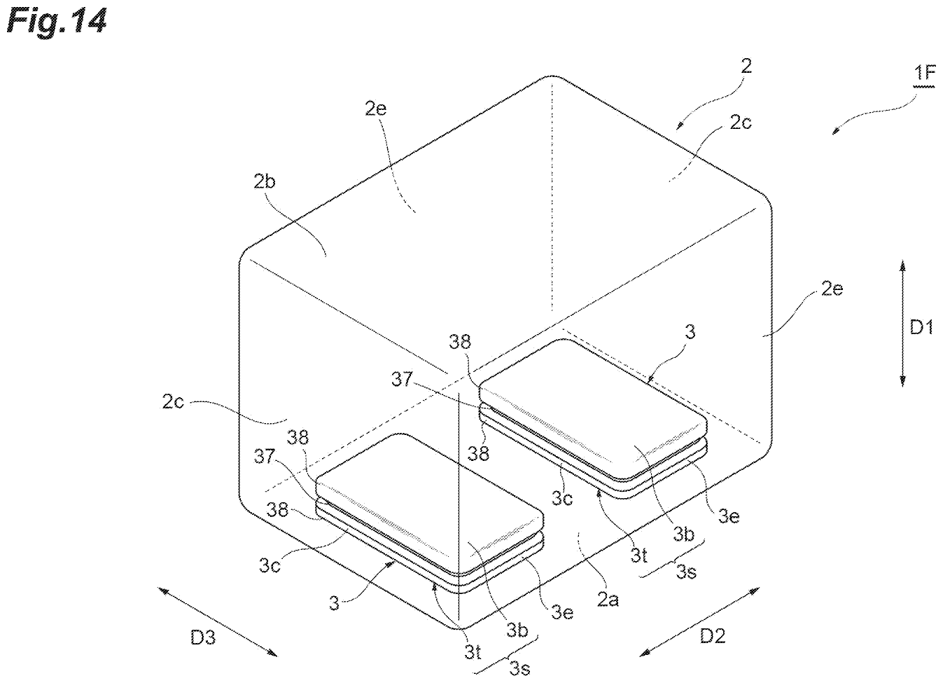

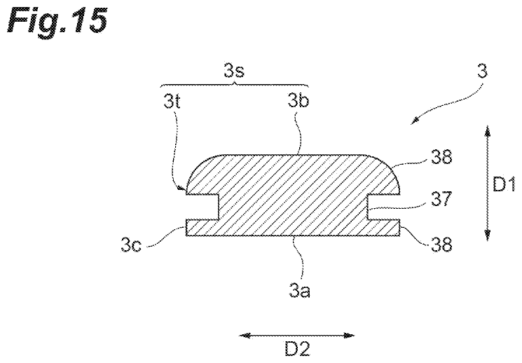

As illustrated in FIGS. 14 and 15, a multilayer coil component 1F according to a third embodiment is different from the multilayer coil component 1 only in that the connecting surfaces 3t of the external terminals 3 have depressions 37 and protrusions 38 and the opposing surface 3b is depression- and protrusion-less. In the multilayer coil component 1F, the connecting surface 3t has an uneven shape and the opposing surface 3b does not have an uneven shape.

In the multilayer coil component 1F, the connecting surface 3t is provided with the depression 37 and the pair of protrusions 38. The depression 37 and the pair of protrusions 38 extend along a direction intersecting with the first direction D1. The depression 37 and the pair of protrusions 38 extend along the third direction D3 on the first connecting surface 3c and extend along the second direction D2 on the second connecting surface 3e. The depression 37 and the pair of protrusions 38 are substantially parallel to the exposed surface 3a. The depression 37 is a notch-shaped groove provided substantially in the middle of the connecting surface 3t in the first direction D1. The pair of protrusions 38 are projections provided on both sides of the depression 37 in the first direction D1. The depression 37 and the pair of protrusions 38 are continuous over the entire circumference of the connecting surface 3t. The depression 37 and the pair of protrusions 38 may be provided only in a partial section of the connecting surface 3t instead of the entire circumference of the connecting surface 3t. For example, the depression 37 may be provided only in the first connecting surface 3c.

Also in the multilayer coil component 1F, the connecting surface 3t is provided with the depression 37 and the protrusion 38, and thus peeling of the external terminal 3 can be suppressed. The depression 37 and the protrusion 38 are provided at each of the pair of first connecting surfaces 3c and the pair of second connecting surfaces 3e, and thus peeling of the external terminal 3 can be reliably suppressed. The depression 37 and the protrusion 38 extend along the exposed surface 3a and in a direction intersecting with the first direction D1. Accordingly, the depression 37 and the protrusion 38 function as anchors and are caught on the element body 2. In particular, the movement of the external terminal 3 in the first direction D1 is suppressed. As a result, peeling of the external terminal 3 can be further suppressed.

Although embodiments and modification examples of the present invention have been described above, the present invention is not necessarily limited thereto and various changes can be made without departing from the gist thereof.

The embodiments and the modification examples may be combined as appropriate. For example, the second connecting surface 3e of the multilayer coil component 1 may be provided with the depression 37 and the pair of protrusions 38 similar to those of the multilayer coil component 1F. The connecting surface 3t of the multilayer coil component 1E may be provided with the depression 37 and the pair of protrusions 38 similar to those of the multilayer coil component 1F. The opposing surface 3b of one of the pair of external terminals 3 may be provided with a depression or a protrusion with the connecting surface 3t of the other external terminal 3 provided with a depression or a protrusion. The inner surface 3s of at least one of the pair of external terminals 3 may be provided with a depression or a protrusion.

What is claimed is:

1. A multilayer coil component comprising:
an element body including a plurality of insulator layers that are laminated;
a coil disposed in the element body; and
a pair of external terminals electrically connected to the coil, wherein
the element body has a rectangular parallelepiped shape and includes a pair of main surfaces opposing each other in a first direction, a pair of end surfaces opposing each other in a second direction intersecting with the first direction, and a pair of side surfaces opposing each other in a third direction intersecting with the first direction and the second direction,
the pair of external terminals are separated from each other in the second direction and are embedded in the element body apart from the pair of end surfaces and the pair of side surfaces,
each of the pair of external terminals includes an exposed surface exposed from one of the main surfaces and an inner surface disposed in the element body, and
the inner surface includes a depression or a protrusion.

2. The multilayer coil component according to claim 1, wherein
the inner surface includes an opposing surface opposing the exposed surface and a connecting surface connecting the exposed surface and the opposing surface, and
the connecting surface includes a depression or a protrusion.

3. The multilayer coil component according to claim 2, wherein
the connecting surface includes a pair of first connecting surfaces opposing each other in the second direction, and
each of the pair of first connecting surfaces includes a depression or a protrusion.

4. The multilayer coil component according to claim 2, wherein
the connecting surface includes a pair of second connecting surfaces opposing each other in the third direction, and
each of the pair of second connecting surfaces includes a depression or a protrusion.

5. The multilayer coil component according to claim 2, wherein the connecting surface includes a depression adjacent to a corner portion of the main surface when viewed from the first direction.

6. The multilayer coil component according to claim 2, wherein the connecting surface includes a depression or a protrusion extending along a direction intersecting with the first direction.

7. The multilayer coil component according to claim 1, wherein
the inner surface includes an opposing surface opposing the exposed surface, and
the opposing surface includes a depression or a protrusion.

8. The multilayer coil component according to claim 7, wherein the opposing surface includes a depression or a protrusion having an annular shape when viewed from the first direction.

9. The multilayer coil component according to claim 1, wherein each of the pair of external terminals includes a plurality of electrode layers that are laminated.

10. The multilayer coil component according to claim 9, wherein the plurality of electrode layers are laminated in such a way that electrode layers having different shapes when viewed from a lamination direction are adjacent to each other.

11. The multilayer coil component according to claim 1, wherein
the plurality of insulator layers that are laminated in the second direction or in the third direction.

12. The multilayer coil component according to claim 3, wherein
the plurality of insulator layers that are laminated in the third direction.

13. The multilayer coil component according to claim 5, wherein
the plurality of insulator layers that are laminated in the second direction.
